(19) United States
(12) Patent Application Publication
(10) Pub. No.: US 2022/0145674 A1
(43) Pub. Date: May 12, 2022

(54) DOOR HANDLE DEVICE

(71) Applicant: AISIN CORPORATION, Kariya (JP)

(72) Inventor: Takaaki KOIZUMI, Kariya-shi (JP)

(73) Assignee: AISIN CORPORATION, Kariya (JP)

(21) Appl. No.: 17/451,349

(22) Filed: Oct. 19, 2021

(30) Foreign Application Priority Data
Nov. 6, 2020 (JP) 2020-185724

(51) Int. Cl. E05B 81/76; E05B 81/78

(52) U.S. Cl. CPC E05B 81/77; E05B 81/78

(57) ABSTRACT

A door handle device provided on a door handle includes: a sensor electrode configured to detect locking and unlocking operations for locking and unlocking a lock of a door according to proximity of a user; a sensor IC configured to control the detection by the sensor electrode; an antenna configured to receive a radio wave propagated from a user terminal and containing an authentication key, and to transmit the radio wave to be propagated toward a periphery; a voltage induction coil configured to generate an induced electromotive force according to the radio wave; a detection unit configured to detect the induced electromotive force generated in the voltage induction coil; and an antenna driving determination unit configured to determine whether the radio wave has been transmitted to and received from the terminal via the antenna based on the induced electromotive force.

### CROSS REFERENCE TO RELATED APPLICATIONS

This application is based on and claims priority under 35 U.S.C. § 119 to Japanese Patent Application 2020-185724, filed on Nov. 6, 2020, the entire content of which is incorporated herein by reference.

### TECHNICAL FIELD

This disclosure relates to a door handle device that is provided on a door handle of a vehicle, and includes a sensor electrode configured to detect a locking operation for locking a lock of a door of the vehicle and an unlocking operation for unlocking the lock according to the proximity of a user and a sensor IC configured to control the detection by that sensor electrode, the door handle device switching the lock between a locked state and an unlocked state according to a detection result of the sensor electrode.

### BACKGROUND DISCUSSION

In the related art, a technique has been used in which a sensor electrode detects an operation by a user for a device and an operation of the device is controlled according to a detection result of the sensor electrode. Examples of such a technique are described in JP 2012-154118A (Reference 1) to be described below.

Reference 1 discloses a door handle device for a vehicle. This vehicle door handle device includes a capacitive sensor and an LF antenna provided on a door handle, and the LF antenna is connected to a sensor board. When the LF antenna is driven, a sensor driving IC detects the driving of the LF antenna to stop an operation of the capacitive sensor while the LF antenna is being driven.

With the technique described in Reference 1, the LF antenna and the capacitive sensor cannot be configured separately because the LF antenna and the capacitive sensor are electrically wired to each other. Further, since a terminal is required to connect the LF antenna to the sensor board, the size of the board increases, and thus, a board mounting space inside the door handle increases, which makes it difficult to downsize the door handle.

A need thus exists for a door handle device which is not susceptible to the drawback mentioned above.

### SUMMARY

A feature of a door handle device according to an aspect of this disclosure resides in that the door handle device is provided on a door handle of a vehicle and includes a sensor electrode configured to detect a locking operation for locking a lock of a door of the vehicle and an unlocking operation for unlocking the lock according to proximity of a user and a sensor IC configured to control the detection by the sensor electrode. The door handle device switches the lock between a locked state and an unlocked state according to a detection result of the sensor electrode, and includes an antenna configured to receive a radio wave propagated from a terminal owned by the user and containing an authentication key for locking and unlocking the lock, and to transmit the radio wave to be propagated toward a periphery, a voltage induction coil configured to generate an induced electromotive force according to the radio wave transmitted and received via the antenna, a detection unit configured to detect the induced electromotive force generated in the voltage induction coil, and an antenna driving determination unit configured to determine whether or not the radio wave has been transmitted to and received from the terminal via the antenna based on the induced electromotive force detected by the detection unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of a door handle on which a door handle device is mounted;

FIG. 2 is a schematic diagram illustrating a configuration of the door handle device;

FIG. 3 is a flowchart illustrating an operation of the door handle device;

FIG. 4 is a timing chart illustrating the operation of the door handle device;

FIG. 5 is a schematic diagram illustrating a configuration of a door handle device according to another embodiment;

FIG. 6 is a schematic diagram illustrating a configuration of a door handle device according to another embodiment;

FIG. 7 is a schematic diagram illustrating a configuration of a door handle device according to another embodiment;

FIG. 8 is a schematic diagram illustrating a configuration of a door handle device according to another embodiment;

FIG. 9 is a schematic diagram illustrating a configuration of a door handle device according to another embodiment; and

FIG. 10 is a schematic diagram illustrating a configuration of a door handle device according to another embodiment.

### DETAILED DESCRIPTION

A door handle device disclosed here is provided on a door handle of a vehicle, and is configured to be able to lock and unlock a lock of a door of the vehicle. Hereinafter, the door handle device 1 of this embodiment will be described.

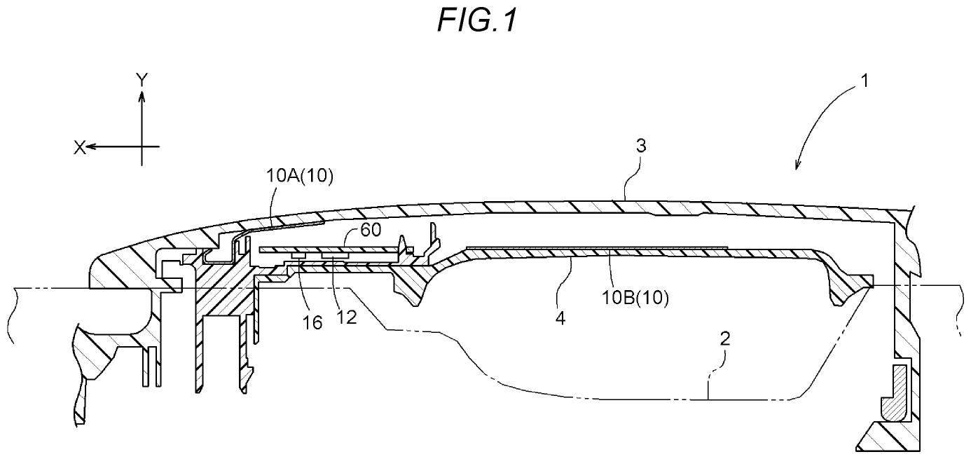

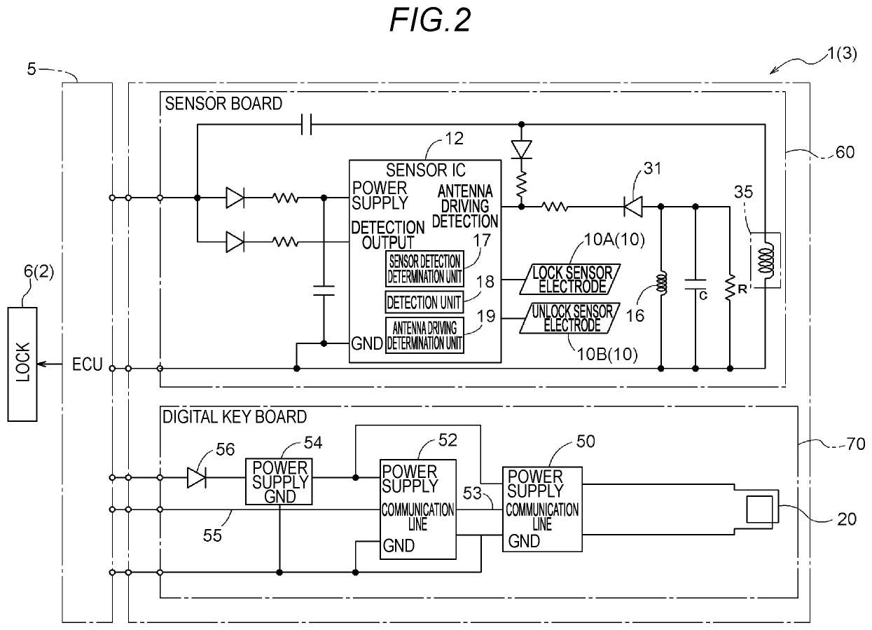

FIG. 1 is a cross-sectional view of a door handle 3 of a vehicle on which the door handle device 1 is mounted. Further, FIG. 2 is a schematic diagram illustrating a configuration of the door handle device 1. As illustrated in FIG. 1, the door handle 3 is provided on a door 2 of the vehicle, and the door handle device 1 is provided on the door handle 3.

As illustrated in FIG. 2, the door handle device 1 is configured to include functional units including a sensor electrode 10, a sensor IC 12, a voltage induction coil 16, a sensor detection determination unit 17, a detection unit 18, an antenna driving determination unit 19, and an antenna 20, and the respective functional units are constructed by hardware or software, or both with a CPU as a core member, in order to perform a processing related to the locking and unlocking of a lock 6 of the door 2.

This door handle device 1 is configured to be able to lock and unlock the lock 6 of the door 2 by an operation performed by a user in proximity. The sensor electrode 10 performs detection of a locking operation for locking the lock 6 of the door 2 of the vehicle and an unlocking operation for unlocking the lock 6 according to the proximity of the user. In this embodiment, sensor electrodes 10 for the locking operation and the unlocking operation are provided separately. Therefore, in order to facilitate understanding, when distinguishing these sensor electrodes 10, the sensor electrode 10 for detecting the locking operation will be referred to as a lock sensor electrode 10A, and the sensor electrode 10 for detecting the unlocking operation will be referred to as an unlock sensor electrode 10B. The lock sensor electrode 10A and the unlock sensor electrode 10B constitute a capacitive sensor to detect the proximity of the user according to a change in capacitance. Such a capacitive sensor is well-known and therefore, a description thereof will be omitted. As illustrated in FIG. 1, the lock sensor electrode 10A is provided on one end side of the door handle 3 in the extension direction (X direction) (for example, the front side in the longitudinal direction of the vehicle) at the opposite side of the door 2 (the outer side in the Y direction), and is provided with a detection area in which the user performs the locking operation. A touch of the user's finger on this detection area corresponds to the locking operation. The unlock sensor electrode 10B is provided at the side opposing the door 2 on a grip portion 4 provided at the center of the door handle 3 in the extension direction, and is provided on the surface thereof with a detection area in which the user performs the unlocking operation. A touch or proximity by the user's hand to this detection area corresponds to the unlocking operation.

The sensor IC 12 controls detection by the sensor electrode 10. The detection by the sensor electrode 10 is the detection of the user's locking operation and unlocking operation by the sensor electrode 10, and includes energization for allowing the sensor electrode 10 to detect a change in capacitance and acquisition of a detection result of the capacitance from the sensor electrode 10. Thus, the sensor IC 12 performs energization to the sensor electrode 10 and acquires the detection result of the capacitance from the sensor electrode 10. To this end, the sensor electrode 10 is electrically connected to the sensor IC 12.

In this embodiment, the sensor IC 12 is provided with the sensor detection determination unit 17, and the sensor detection determination unit 17 determines whether or not the sensor electrode 10 has detected the user's hand based on the detection result of the capacitance acquired from the sensor electrode 10, and outputs a signal for unlocking or locking the lock 6 of the door 2 to an ECU 5 as a control device based on the determination result. In other words, the sensor detection determination unit 17 outputs a signal for switching the lock 6 from a locked state to an unlocked state to the ECU 5 based on information acquired from the lock sensor electrode 10A (based on the detection of a lock sensor). Further, the sensor detection determination unit 17 outputs a signal for switching the lock 6 from the unlocked state to the locked state to the ECU 5 based on information acquired from the unlock sensor electrode 10B (based on the detection of an unlock sensor). Accordingly, the sensor detection determination unit 17 also functions as a lock state switching signal transmitter in such a configuration.

The output of the signal for unlocking or locking the lock 6 of the door 2 from the sensor detection determination unit 17 to the ECU 5 may be performed from a detection output terminal of the sensor IC 12 through a power supply wire to which a positive potential is applied among a pair of power supply wires which interconnect the ECU 5 and a sensor board 60.

When acquiring the signal for unlocking the lock 6 of the door 2 from the sensor detection determination unit 17, the ECU 5 switches the lock 6 from the locked state to the unlocked state. Meanwhile, when acquiring the signal for locking the lock 6 of the door 2 from the sensor detection determination unit 17, the ECU 5 switches the lock 6 from the unlocked state to the locked state. Accordingly, the ECU 5 functions as a lock state switcher in such a configuration.

In this embodiment, the lock sensor electrode 10A, the unlock sensor electrode 10B, and the sensor IC 12 described above are provided on the sensor board 60.

This door handle device 1 switches the lock 6 between the locked state and the unlocked state according to the detection result of the sensor electrode based on an operation of the user in proximity (touch operation) as described above, but the lock 6 is also configured to be switchable by an operation of a remote controller (mobile device). Since such switching by the remote controller is well known, a detailed description thereof will be omitted, but an antenna (LF antenna) 35 is provided for information transmission with the remote controller. Furthermore, in addition to this, the lock 6 is configured to be switchable between the locked state and the unlocked by communication using a terminal such as, for example, a smart phone. The door handle device 1 communicates with such a terminal using a radio wave.

Therefore, the door handle device 1 is provided with the antenna 20, which receives a radio wave propagated from a terminal owned by the user, the radio wave including an authentication key for locking and unlocking the lock 6, and transmits a radio wave to be propagated toward the periphery. The terminal owned by the user is, for example, a device capable of transmitting information via a radio wave, and corresponds to, for example, a smart phone. For this reason, when it is desired to lock or unlock the lock 6 of the door 2, the user gives a locking or unlocking instruction via the smart phone. This locking or unlocking instruction is given as the smart phone transmits the radio wave on which the authentication key is superimposed, and the antenna 20 receives this radio wave. Transmitting the radio wave to be propagated toward the periphery means transmitting the radio wave from the antenna 20 in a direction according to the directivity of that antenna 20. When the terminal receives the transmitted radio wave, the terminal is able to perform communication via the antenna 20. For example, the transmission and reception of such a radio wave may be performed by near field communication (hereinafter referred to as “NFC”). In this case, an NFC antenna is used as the antenna 20.

The antenna 20 is mounted on a digital key board 70 different from the sensor board 60. The digital key board 70 is also incorporated in the door handle 3 (although not illustrated in FIG. 1). The digital key board 70 is provided with an NFC IC 50 which performs energization of the antenna 20, a microcomputer 52 which mediates between the NFC IC 50 and a host system, a regulator 54 which controls the electric power supplied to the microcomputer 52 to a constant voltage, and a reverse connection preventing diode 56. The NFC IC 50 and the microcomputer 52 are connected by a communication line 53, and the microcomputer 52 is provided with another communication wire 55 so as to be able to communicate with the host system.

The voltage induction coil 16 performs inductive coupling with the antenna 20 to generate an induced electromotive force according to the radio wave transmitted and received via the antenna 20. Further, the voltage induction coil 16 also performs inductive coupling with the antenna 35 to generate an induced electromotive force according to the radio wave transmitted and received via the antenna 35. The voltage induction coil 16 is provided on the sensor board 60, so that an induced electromotive force is generated in the voltage induction coil 16 according to current when that current flows through the antenna 20 by NFC with the terminal. The induced electromotive force generated in the voltage induction coil 16 is input to the detection unit 18 through a diode 31.

As described above, the voltage induction coil 16 is provided on the sensor board 60, but may be provided on the sensor board 60, for example, by soldering when the voltage induction coil 16 is configured by using components. Alternatively, the voltage induction coil 16 may be formed in a wiring pattern in which a conductor is disposed on the sensor board 60. In this case, the number of components may be reduced. Further, the voltage induction coil 16 is provided with a resonance condenser C and a resistor R which are in parallel with the voltage induction coil 16. Thus, when a parallel resonance circuit is configured with the voltage induction coil 16 and the resonance condenser, it is possible to increase the induced electromotive force. Furthermore, the impedance and the Q value may be set according to the resistance value of the resistor so as to suit to the strength of inductive coupling or a variation in the driving frequency of the antenna 20.

The detection unit 18 detects the induced electromotive force generated in the voltage induction coil 16. In this embodiment, the detection unit 18 is incorporated in the sensor IC 12. The induced electromotive force generated in the voltage induction coil 16 is pulsating. Therefore, when detecting such a pulsating induced electromotive force, the detection unit 18 outputs a signal indicating detection of the induced electromotive force with respect to the sensor IC 12. Such a signal may be a direct current signal. For example, the detection unit 18 may convert a voltage from the voltage induction coil 16 into direct current to output the direct current.

The antenna driving determination unit 19 determines whether or not the radio wave has been transmitted to and received from the terminal via the antenna 20 based on the induced electromotive force detected by the detection unit 18. In this embodiment, the antenna driving determination unit 19 is incorporated in the sensor IC 12, and a detection result from the detection unit 18 is transmitted to the antenna driving determination unit 19. The antenna driving determination unit 19 determines that the radio wave has been transmitted to and received from the terminal via the antenna 20 when the level (wave height) of the signal from the detection unit 18 is equal to or greater than a predetermined threshold, and determines that the radio wave has not been transmitted to and received from the terminal via the antenna 20 when the level (wave height) of the signal from the detection unit 18 is less than the threshold. When the antenna driving determination unit 19 determines that radio wave has been transmitted to and received from the terminal via the antenna 20, the sensor IC 12 temporarily prohibits energization to the sensor electrode 10 over a predetermined time.

When the radio wave has been transmitted to and received from the terminal via the antenna 20, the microcomputer 52 transmits a lock state switching signal to the ECU 5 through the communication line 55. The ECU 5 switches the lock 6 between the locked state and the unlocked state when acquiring this lock state switching signal. Specifically, when the lock 6 is in the locked state, the ECU 5 unlocks the lock 6 when acquiring the lock state switching signal from the microcomputer 52. Meanwhile, when the lock 6 is in the unlocked state, the ECU 5 locks the lock 6 when acquiring the lock state switching signal from the microcomputer 52. In this way, the door handle device 1 is configured to switch the lock 6 between the locked state and the unlocked state even by the operation of the terminal.

Returning to FIG. 1, in this embodiment, the voltage induction coil 16 and the sensor electrode 10 (the lock sensor electrode 10A in this embodiment) are provided on opposite sides with the sensor board 60 on which the sensor IC 12 is mounted therebetween. Thus, the sensor electrode 10 may be prevented from malfunctioning due to the induced electromotive force from the voltage induction coil 16.

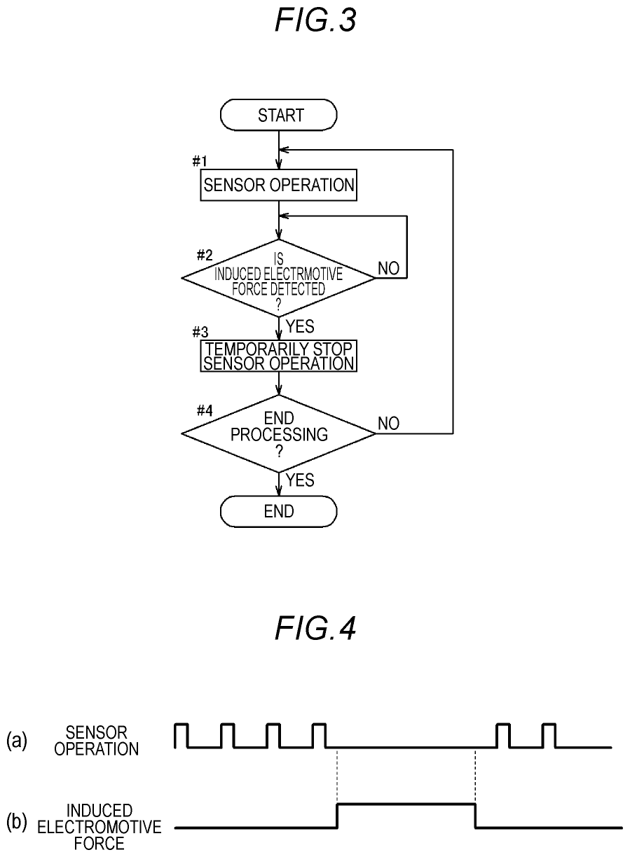

Next, a processing of the door handle device 1 will be described using the flowchart of FIG. 3. First, the sensor electrode 10 is energized to start a sensor operation (step #1). In this state, when the induced electromotive force generated in the voltage induction coil 16 is detected (step #2: Yes), energization to the sensor electrode 10 is temporarily stopped. Thus, the sensor operation is temporarily stopped (step #3). When energization to the sensor electrode 10 is stopped over a predetermined time and the processing is not ended as it is (step #4: No), the processing returns to step #1 and is continued.

This state is illustrated in FIG. 4. That is, although the sensor electrode 10 is energized at a predetermined time interval, energization to the sensor electrode 10 is temporarily stopped when the induced electromotive force generated in the voltage induction coil 16 is detected. After energization to the sensor electrode 10 is stopped over a predetermined time, energization to the sensor electrode 10 is restarted. Thus, it is possible to stably operate the sensor when the antenna 20 does not transmit and receive the radio wave, so that power consumption of the sensor may be reduced.

Further, since the antenna 20 and the sensor do not operate at the same time, malfunction may be prevented. Specifically, since a voltage is induced in the resonance circuit to suit to the driving frequency of the antenna 20, the stop of the sensor operation may be limited to the time of oscillation of the antenna 20. The processing of the door handle apparatus 1 is performed as described above.

### OTHER EMBODIMENTS

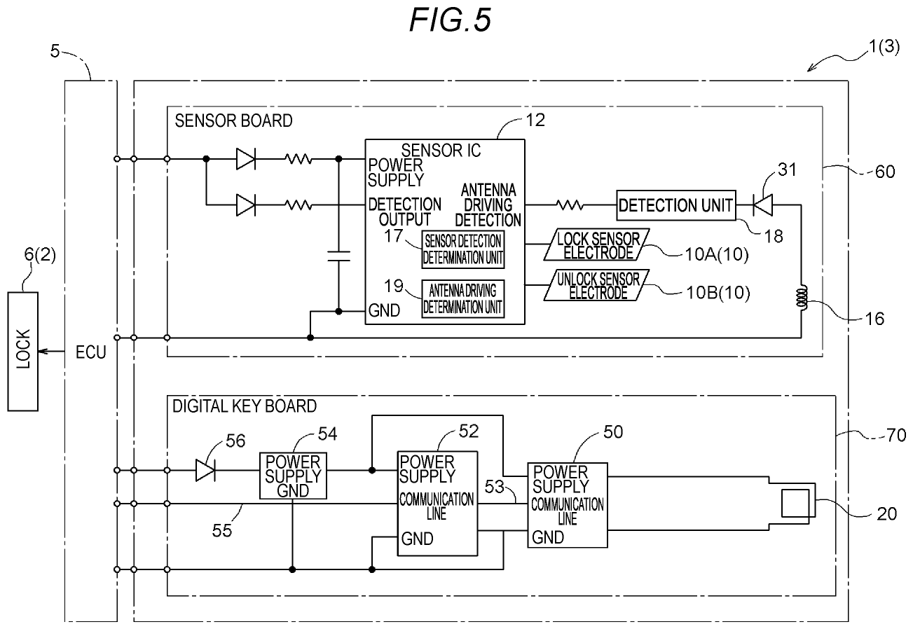

In the above embodiment, the door handle device 1 has been described as having the antenna 35 which communicates with the remote controller, but as illustrated in FIG. 5, it may be configured without having the antenna 35 and any component associated with the driving of the antenna 35 (for example, a condenser connected to one side terminal of the antenna 35).

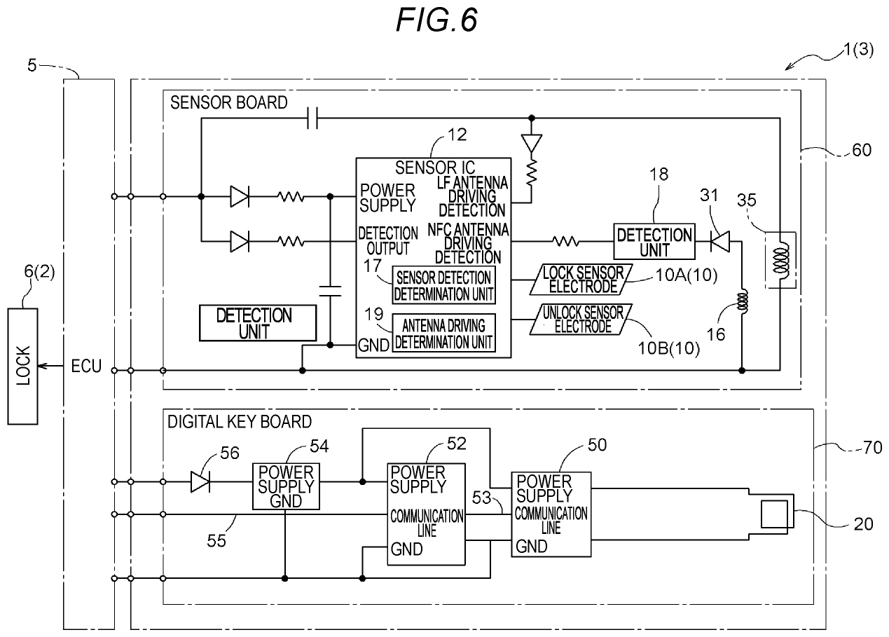

In the above embodiment, with respect to the sensor IC 12 in FIG. 2, the antenna 35 and the voltage induction coil 16 is illustrated as being connected to a single terminal (driving detection terminal). However, as illustrated in FIG. 6, the antenna 35 and the voltage induction coil 16 may also be configured to be separately connected to the sensor IC 12 (for example, an LF antenna driving detection terminal and an NFC antenna driving detection terminal), respectively. Further, the circuit may be configured without providing the condenser C and the resistor R in parallel with the voltage induction coil 16, and the detection unit 18 may be configured in the form of an external component of the sensor IC 12.

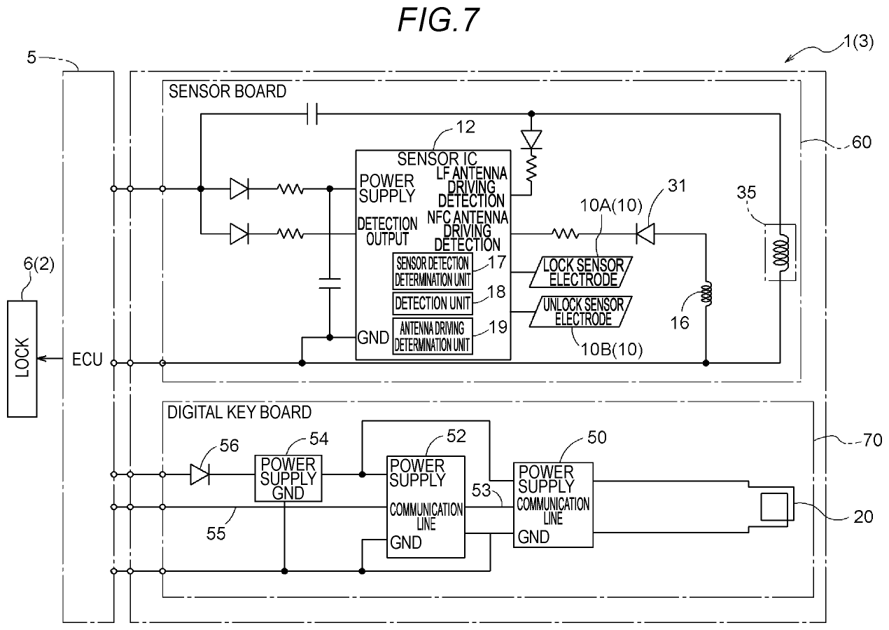

Of course, as illustrated in FIG. 7, the antenna 35 and the voltage induction coil 16 may be configured to be separately connected to the sensor IC 12 (for example, the LF antenna driving detection terminal and the NFC antenna driving detection terminal), respectively, the circuit may be configured without providing the condenser C and the resistor R in parallel with the voltage induction coil 16, and the detection unit 18 may be incorporated in the sensor IC 12.

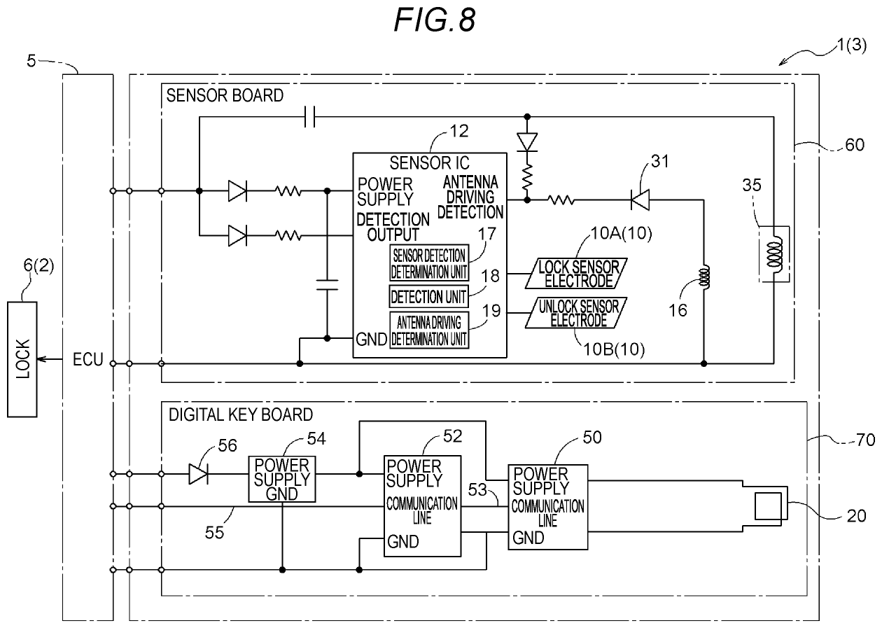

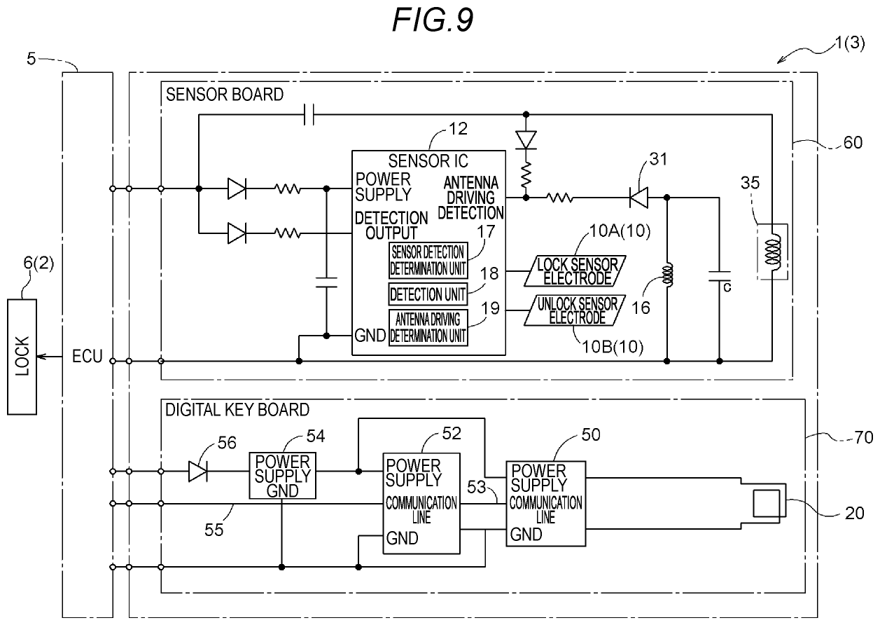

Further, as illustrated in FIG. 8, the circuit of FIG. 2 may be configured without providing the condenser C and the resistor R in parallel with the voltage induction coil 16. Furthermore, as illustrated in FIG. 9, the circuit of FIG. 2 may be configured by providing only the condenser C in parallel with the voltage induction coil 16.

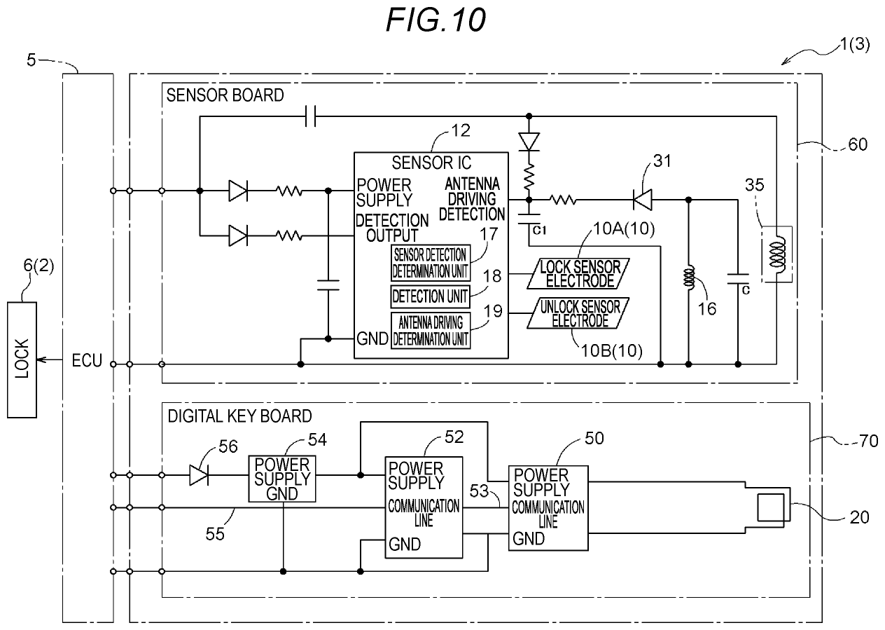

Further, as illustrated in FIG. 10, a voltage smoothing capacitor C1 may be provided at a terminal of the sensor IC 12 to which the induced electromotive force is input from the voltage induction coil 16. Thus, the detection unit 18 may appropriately detect the induced electromotive force.

Further, the antenna 20 may be configured by providing a plurality of antennas such as, for example, NFC antennas and LF antennas. In this case, the antennas may be configured such that at least one of the plurality of antennas 20 performs the inductive coupling with the voltage induction coil 16. Even in such a case, it is possible to achieve low power consumption and low costs of the door handle device 1.

Of course, the antennas may also be configured such that each of at least two or more antennas 20 among the plurality of antennas 20 performs the inductive coupling with the voltage induction coil 16. In this case, the detection unit 18 may detect an induced electromotive force according to the radio wave transmitted and received via each of the two or more antennas 20. The detection unit 18 may be configured to be able to determine whether the induced electromotive force is generated according to the radio wave transmitted and received from which antenna 20 among the two or more antennas 20.

In the above embodiment, the antenna 20 has been described as using an NFC antenna, but may be, for example, a Bluetooth (registered trademark) antenna or an Ultra-Wide-Band (UWB) communication antenna.

In the above embodiment, the lock sensor electrode 10A and the unlock sensor electrode 10B have been described as constituting the capacitive sensor, but the sensor may be replaced with an ultrasonic sensor or an IR sensor. In this case, the lock sensor electrode 10A and the unlock sensor electrode 10B may be an electrode that detects ultrasonic waves or an electrode that detects IR.

In the above embodiment, the door handle device 1 has been described as including the sensor board 60 and the digital key board 70, i.e., as having a smart key function provided in the sensor board 60 and a digital key function provided in the digital key board 70, but the digital key function and the smart key function may be provided separately, and a smart key may later be expanded to configure (add on) a digital key.

This disclosure may be used in a door handle device which is provided on a door handle of a vehicle, and includes a sensor electrode to detect a locking operation for locking a lock of a door of the vehicle and an unlocking operation for unlocking the lock according to the proximity of a user and a sensor IC to control the detection by that sensor electrode, the door handle device switching the lock between a locked state and an unlocked state according to a detection result of the sensor electrode.

A feature of a door handle device according to an aspect of this disclosure resides in that the door handle device is provided on a door handle of a vehicle and includes a sensor electrode configured to detect a locking operation for locking a lock of a door of the vehicle and an unlocking operation for unlocking the lock according to proximity of a user and a sensor IC configured to control the detection by the sensor electrode. The door handle device switches the lock between a locked state and an unlocked state according to a detection result of the sensor electrode, and includes an antenna configured to receive a radio wave propagated from a terminal owned by the user and containing an authentication key for locking and unlocking the lock, and to transmit the radio wave to be propagated toward a periphery, a voltage induction coil configured to generate an induced electromotive force according to the radio wave transmitted and received via the antenna, a detection unit configured to detect the induced electromotive force generated in the voltage induction coil, and an antenna driving determination unit configured to determine whether or not the radio wave has been transmitted to and received from the terminal via the antenna based on the induced electromotive force detected by the detection unit.

With such a configuration, the antenna can be configured with a board separate from each of the voltage induction coil and the sensor electrode in a state of being able to communicate with the voltage induction coil without using a cable. Accordingly, since the degree of freedom for the arrangement of these boards inside the handle may be increased, it is possible to enhance the design property of the handle.

It is preferable that the voltage induction coil and the sensor electrode are provided on opposite sides with a board on which the sensor IC is mounted interposed therebetween.

With such a configuration, the sensor electrode 10 can be prevented from malfunctioning due to the induced electromotive force from the voltage induction coil 16.

It is preferable that the door handle device further includes a control device configured to control the sensor electrode, and the control device stops energization to the sensor electrode when the detection unit detects the induced electromotive force generated in the voltage induction coil.

With such a configuration, malfunction can be prevented since the antenna and the sensor do not operate at the same time.

It is preferable that, the antenna is a near field communication antenna.

With such a configuration, power consumption of the antenna can be reduced.

It is preferable that the detection unit is incorporated in the sensor IC.

With such a configuration, a further simplified structure can be achieved, and thus, it is possible to achieve a low cost and compact configuration.

It is preferable that the antenna includes a plurality of the antennas, and at least one of the plurality of antennas performs inductive coupling with the voltage induction coil.

With such a configuration, the inducted electromotive force can be generated in the voltage induction coil by the transmission and reception of the radio wave via at least one antenna. Accordingly, it is possible to detect the transmission and reception of the radio wave via at least one antenna.

It is preferable that each of at least two or more antennas among the plurality of antennas performs the inductive coupling with the voltage induction coil, and the detection unit detects the induced electromotive force according to the radio wave transmitted and received via each of the two or more antennas.

With such a configuration, the voltage induction coil can be shared by two or more antennas, and thus, it is possible to achieve a simplified structure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A door handle device provided on a door handle of a vehicle and comprising:
a sensor electrode configured to detect a locking operation for locking a lock of a door of the vehicle and an unlocking operation for unlocking the lock according to proximity of a user; and
a sensor IC configured to control the detection by the sensor electrode, the door handle device switching the lock between a locked state and an unlocked state according to a detection result of the sensor electrode,
the door handle device further comprising:
an antenna configured to receive a radio wave propagated from a terminal owned by the user and containing an authentication key for locking and unlocking the lock, and to transmit the radio wave to be propagated toward a periphery;
a voltage induction coil configured to generate an induced electromotive force according to the radio wave transmitted and received via the antenna;
a detection unit configured to detect the induced electromotive force generated in the voltage induction coil; and
an antenna driving determination unit configured to determine whether or not the radio wave has been transmitted to and received from the terminal via the antenna based on the induced electromotive force detected by the detection unit.

2. The door handle device according to claim 1, wherein
the voltage induction coil and the sensor electrode are provided on opposite sides with a board on which the sensor IC is mounted interposed therebetween.

3. The door handle device according to claim 1, further comprising
a control device configured to control the sensor electrode, wherein
the control device stops energization to the sensor electrode when the detection unit detects the induced electromotive force generated in the voltage induction coil.

4. The door handle device according to claim 1, wherein
the antenna is a near field communication antenna.

5. The door handle device according to claim 1, wherein
the detection unit is incorporated in the sensor IC.

6. The door handle device according to claim 1, wherein
the antenna includes a plurality of the antennas, and at least one of the plurality of antennas performs inductive coupling with the voltage induction coil.

7. The door handle device according to claim 6, wherein
each of at least two or more antennas among the plurality of antennas performs the inductive coupling with the voltage induction coil, and the detection unit detects the induced electromotive force according to the radio wave transmitted and received via each of the two or more antennas.
